(19) United States
(12) Patent Application Publication
(10) Pub. No.: US 2025/0242789 A1
(43) Pub. Date: Jul. 31, 2025

(54) ARRANGEMENT FOR MOUNTING AN EMERGENCY BRAKING SYSTEM TO A VEHICLE

(71) Applicant: Volvo Autonomous Solutions AB, Göteborg (SE)

(72) Inventors: Vinaya KUMAR, Göteborg (SE); Ferdinand KANKE, Göteborg (SE)

(73) Assignee: Volvo Autonomous Solutions AB, Göteborg (SE)

(21) Appl. No.: 19/032,749

(22) Filed: Jan. 21, 2025

(30) Foreign Application Priority Data
Jan. 30, 2024 (EP) 24154709.0

(51) Int. Cl. B60T 15/04; B60T 7/16

(52) U.S. Cl. CPC B60T 15/041; B60T 7/16

(57) ABSTRACT

A mounting arrangement mounts an emergency braking system to a vehicle. A bracket mounts a set of components. The set of components comprise at least a backup brake valve arrangement and a manual valve for selectively enabling activation of the backup brake valve arrangement. A lid is pivotably mounted to the bracket. The lid is arranged to allow access to the manual valve mounted to the bracket when the lid is open, and wherein the lid is arranged to lock the manual valve to one of an open valve position and a closed valve position when the lid is closed. The bracket is configured as a protective cover at least partially enclosing the set of components when mounted thereto.

### TECHNICAL FIELD

The disclosure relates generally to a mounting arrangement for vehicle applications. In particular aspects, the disclosure relates to a mounting arrangement for mounting of an emergency braking system to a vehicle, to an emergency braking system, and to a vehicle, in particular an autonomous vehicle. The disclosure can be applied to heavy-duty vehicles, such as trucks, buses, and construction equipment, among other vehicle types.

Although the disclosure may be described with respect to a particular vehicle, the disclosure is not restricted to any particular vehicle.

### BACKGROUND

Autonomous vehicles are considered for use in many applications in which the vehicles are operated in a confined area, such as in a work site, a quarry, a harbor, etc., where there are no or few uncontrolled traffic participants. An autonomous vehicle must for safety reasons be equipped with an emergency brake system that can stop the vehicle during unforeseen emergency situations. However, for driving the vehicle along a public road, such as for transporting it to and from the confined area, it is desirable to provide a manual driving mode in addition to the autonomous driving mode. In the manual driving mode, when the vehicle is operated by a driver, the emergency brake system should be inactive to prevent sudden stops of the vehicle. The driver must therefore be able to easily switch off the emergency brake system in the manual driving mode.

### SUMMARY

According to a first aspect of the disclosure, a mounting arrangement for mounting of an emergency braking system to a vehicle is provided. The mounting arrangement comprises:
a bracket configured to mount a set of components, wherein the set of components comprise at least a backup brake valve arrangement and a manual valve for selectively enabling activation of the backup brake valve arrangement,
a lid pivotably mounted to the bracket, wherein the lid is arranged to allow access to the manual valve mounted to the bracket when the lid is open, and wherein the lid is arranged to lock the manual valve to one of an open valve position and a closed valve position when the lid is closed,

wherein the bracket is configured as a protective cover at least partially enclosing the set of components when mounted thereto.

The first aspect of the disclosure may seek to provide an in at least some aspect improved mounting arrangement for mounting of an emergency braking system to a vehicle. A technical benefit may include an ability to protect the backup brake valve arrangement of the emergency braking system from environmental pollutants, while at the same time allowing an operator, such as a driver, to access the manual valve to enable and disable activation of the emergency braking system. Furthermore, since the lid is arranged to lock the manual valve to the selected valve position once the lid is closed, unintentional changes in the valve position, due to vibrations or similar, is prevented during driving.

The manual valve may be configured to selectively fluidly connect the backup brake valve arrangement to a compressed air source, such as to an air distribution device of the vehicle. The air distribution device may be configured to distribute and control flow of compressed air to various pneumatic systems of the vehicle, such as to the emergency braking system. Hence, by operating the manual valve, the operator can enable or disable activation of the emergency braking system.

Optionally in some examples, including in at least one preferred example, the mounting arrangement further comprises a handle configured to be assembled with the manual valve to enable opening and closing of the manual valve. A technical benefit may include facilitated operation of the manual valve. The handle may be configured for opening and closing of the valve by rotating the handle.

Optionally in some examples, including in at least one preferred example, the handle comprises a first engagement member configured to engage with at least one second engagement member of the lid to lock the manual valve. A technical benefit may include a robust locking of the manual valve to the lid in one of the valve positions, preferably in both valve positions. Preferably, two second engagement members are provided in the lid.

Optionally in some examples, including in at least one preferred example, the first engagement member is a male engagement member, and the at least one second engagement member comprises first and second through-holes configured for receiving the first engagement member in the open and closed valve positions, respectively. A technical benefit may include that an operator can easily see, just by looking at the lid, whether the manual valve is closed or opened. A visual indicator, such as a label or similar, may also be provided on the lid to guide the operator.

Optionally in some examples, including in at least one preferred example, the mounting arrangement further comprises first and second stopping members attached to the bracket and arranged to prevent movement of the handle beyond positions corresponding to the open and closed valve positions, respectively. The first and second stopping members restrict a range of motion of the handle such that it may only be moved between a first position corresponding to the open valve position and a second position corresponding to the closed valve position. A technical benefit may include facilitated operation of the manual valve.

Optionally in some examples, including in at least one preferred example, the mounting arrangement further comprises a set of sensors mounted to the bracket, wherein the set of sensors comprises a first sensor arranged to detect when the lid is closed. A technical benefit may include the possibility to use signals from the set of sensors to indicate a state of the emergency braking system. In particular, a signal from the first sensor may be used to indicate that the lid is closed and hence that the manual valve is set to one of its two valve positions.

Optionally in some examples, including in at least one preferred example, the first sensor is an inductive sensor. A technical benefit may include robust detection of the closed lid when the lid is metallic or comprises a metal member fixed to the lid.

Optionally in some examples, including in at least one preferred example, the set of sensors further comprises a second sensor configured to detect when the manual valve is in the open valve position and/or a third sensor configured to detect when the manual valve is in the closed valve position. A technical benefit may include the possibility to use signals from the second and/or third sensor to indicate to which valve position the manual valve is set, and hence whether a manual driving mode or an autonomous driving mode of the vehicle should be selected. Preferably, the mounting arrangement comprises the second and the third sensor such that both valve positions can be detected. The second and/or the third sensor may be an inductive sensor. In this case, the handle should be metallic or comprise a metallic component fixed thereto such that a sufficiently strong sensor signal is generated.

Optionally in some examples, including in at least one preferred example, the mounting arrangement further comprises a locking member, such as a latch, configured to releasably lock the lid in a closed lid position. A technical benefit may include that the lid can be secured in its closed position during driving, while it can be unlocked by the operator for operating the manual valve.

Optionally in some examples, including in at least one preferred example, in the closed valve position, the backup brake valve arrangement is inactive, and, in the open valve position, the backup brake valve arrangement is active. In the closed valve position, a fluid connection between the compressed air source and the backup brake valve arrangement is blocked. The manual valve is hence open for autonomous driving and closed for manual driving.

Optionally in some examples, including in at least one preferred example, the bracket comprises an open side, wherein the bracket is configured to be mounted with the open side toward a housing of an air distribution device of the vehicle. A technical benefit may include easy connection of pneumatic hoses and/or electrical connectors between the air distribution device and the backup brake valve arrangement and/or the sensors. Furthermore, by mounting the bracket right next to the housing of the air distribution device, it can be ensured that the distance between the backup brake valve arrangement and the air distribution device is sufficiently short to avoid pressure drop, thereby ensuring quick activation of the emergency brake system when needed.

Optionally in some examples, including in at least one preferred example, the mounting arrangement is configured to be mounted in a space provided between the housing of the air distribution device and a fuel tank of the vehicle. A technical benefit may include the provision of a sufficiently short distance between the air distribution system and the backup brake valve arrangement.

According to a second aspect of the disclosure, an emergency braking system of a vehicle is provided, comprising a backup brake valve arrangement, a manual valve for selectively activating the backup brake valve arrangement, and the mounting arrangement of the first aspect of the disclosure. The second aspect of the disclosure may seek to provide an in at least some aspect improved emergency braking system for a vehicle. A technical benefit may include the provision of an emergency braking system which is well protected from environmental pollutions but yet easily accessible to an operator to change driving modes of the vehicle.

Advantageous examples and further technical benefits of the second aspect appear from the above description of examples and technical benefits of the first aspect of the disclosure.

According to a third aspect of the disclosure, a vehicle comprising the emergency braking system according to the second aspect is provided. The vehicle may be a heavy-duty vehicle such as a bus, a truck, or a working machine. The vehicle may further comprise an air distribution device such as described above to which the backup brake valve arrangement is selectively fluidly connectable via the manual valve.

Optionally in some examples, including in at least one preferred example, the vehicle is configured to be operated in an autonomous driving mode when the backup valve arrangement is active, and in a manual driving mode when the backup brake valve arrangement is inactive. The mode may e.g. be set in response to receiving signals from the set of sensors described above in connection with the first aspect.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 schematically illustrates an exemplary vehicle according to an example.

FIG. 2 is a perspective view of a mounting arrangement according to an example.

FIG. 3a is a side view of the mounting arrangement in FIG. 2 with a closed lid.

FIG. 3b is a side view of the mounting arrangement in FIG. 2 with an open lid.

FIG. 4 is a top view of the mounting arrangement in FIG. 2.

FIG. 5 is a rear view of the mounting arrangement in FIG. 2.

FIG. 6 is a front view of the mounting arrangement according to an example.

The drawings are schematic and not necessarily drawn to scale.

### DETAILED DESCRIPTION

The detailed description set forth below provides information and examples of the disclosed technology with sufficient detail to enable those skilled in the art to practice the disclosure.

Autonomous vehicles are useful for transports in confined areas where there are no or few uncontrolled traffic participants. An autonomous vehicle must for safety reasons be equipped with an emergency brake system that can stop the vehicle during unforeseen emergency situations. However, for driving the vehicle along a public road, such as for transporting it to and from the confined area, it is desirable to provide a manual driving mode in addition to the autonomous driving mode. In the manual driving mode, the vehicle is operated by a driver, and it is undesirable to have the emergency braking system active since this may lead to sudden stops of the vehicle. The driver should therefore be able to easily disable the emergency braking system in the manual driving mode. A manual valve may be used for this purpose. The manual valve should be located between an air distribution device of the vehicle, distributing compressed air to vehicle systems, and a backup brake valve arrangement used to actuate the brakes in case of emergency. The backup brake valve arrangement must however be possible to actuate quickly, and it should therefore be located as close as possible to the air distribution device to avoid pressure drops. This restricts the possibilities to position the manual valve where it can easily be accessed by the driver.

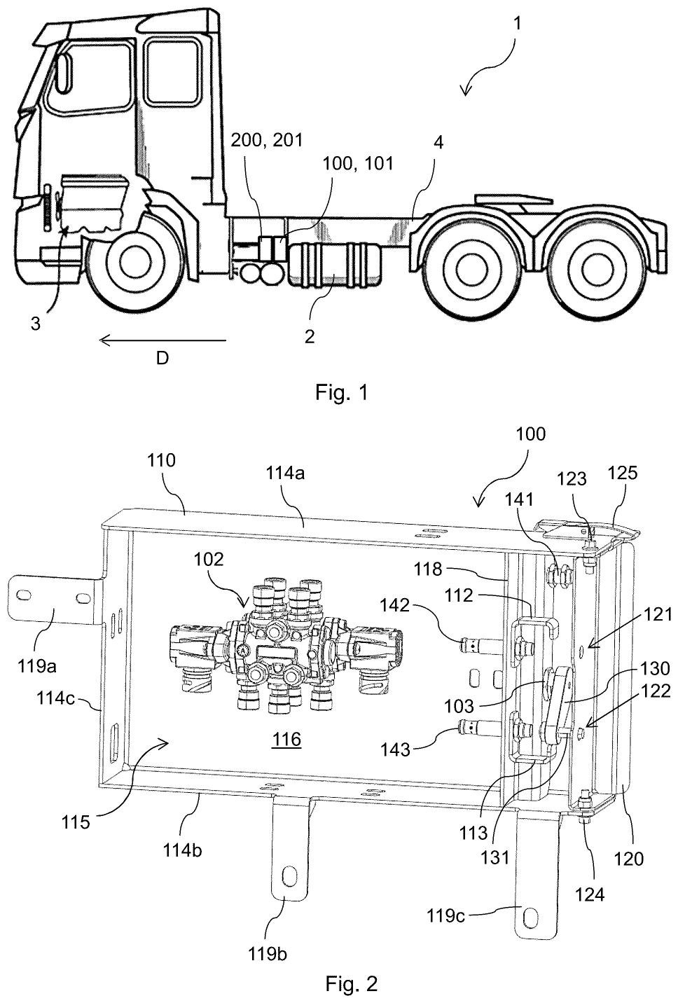

FIG. 1 illustrates a vehicle 1 in the form of a heavy-duty truck being provided

with an autonomous driving mode, i.e., a driverless driving mode, and a manual driving mode in which the vehicle is configured to be driven by a human driver. The vehicle 1 comprises an engine 3 providing propulsion power to drive the vehicle 1. A fuel tank 2 is mounted to a frame 4 of the vehicle 1. The vehicle 1 further comprises an emergency braking system 101 mounted to the vehicle 1 by means of a mounting arrangement 100, and an air distribution device 200 provided in a housing 201 mounted to the frame 4 of the vehicle 1, in front of the fuel tank 2 as seen in a forward driving direction D of the vehicle. The emergency braking system 101 is configured to be active in the autonomous driving mode and should be disabled in the manual driving mode. It is mounted in a space provided between the air distribution device 200 and the fuel tank 2.

FIG. 2 illustrates a mounting arrangement 100 according to an example of the disclosure. The mounting arrangement 100 is configured for mounting of an emergency braking system 101 to a vehicle 1, such as illustrated in FIG. 1. It comprises a bracket 110 configured to mount a set of components of the emergency braking system 101. The bracket 110 is configured as a protective cover at least partially enclosing the set of components when the set of components is mounted thereto. The set of components includes at least a backup brake valve arrangement 102 and a manual valve 103 for selectively enabling activation of the backup brake valve arrangement 102, such as in the autonomous driving mode. The manual valve 103 is arranged to selectively provide a fluid connection between the air distribution device 200 and the backup brake valve arrangement. It is for this purpose movable between an open valve position and a closed valve position. Hoses and fittings (not shown) may be provided for providing fluid connections.

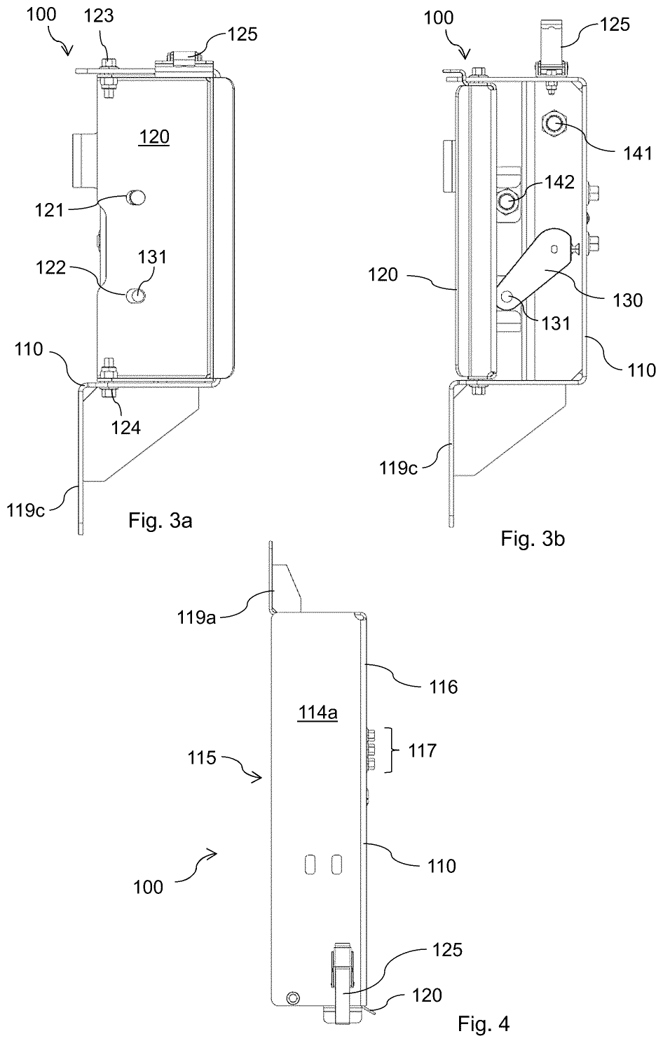

A lid 120 is pivotably mounted to the bracket 110 by means of connecting elements 123, 124. FIGS. 3a and 3b illustrate the mounting arrangement 100 in a side view, with the lid 120 in a closed lid position and an open lid position, respectively. The lid 120 is arranged to allow access to the manual valve 103 mounted to the bracket 110 when the lid 120 is open. The lid 120 is further arranged to lock the manual valve 103 to one of an open valve position and a closed valve position when the lid 120 is closed. In the illustrated example, this is achieved by providing a handle 130 assembled with the manual valve 103 to enable opening and closing of the manual valve 103 by rotation of the handle 130. The handle 130 comprises a first engagement member 131 configured to engage with at least one second engagement member 121, 122 of the lid 120 to lock the manual valve 103. The first engagement member 131 may be a male engagement member, as in the illustrated example, and the at least one second engagement member may be a first and a second through-hole 121, 122 configured to receive the male engagement member 131 in the open and closed valve positions, respectively. However, other configurations are possible, such as providing the handle with a female engagement member and the lid with two male engagement members.

As best illustrated in FIG. 2, first and second stopping members 112, 113 arranged to prevent movement of the handle 130 beyond positions corresponding to the open and closed valve positions, respectively, are attached to the bracket 110. The first and second stopping members 112, 113 restrict a range of motion of the handle 130 such that it may only be moved between a first position corresponding to the open valve position and a second position corresponding to the closed valve position.

A set of sensors are further mounted to the bracket 110. The set of sensors comprises a first sensor 141 arranged to detect when the lid is closed, a second sensor 142 arranged to detect when the manual valve 103 is in the open valve position and a third sensor 143 configured to detect when the manual valve 103 is in the closed valve position. The first, second and third sensors 141, 142, 143 are in the illustrated example inductive sensors, although any kind of proximity sensors may be used. The male engagement member 131 of the handle 130 may be a steel element, or another metal element, that can easily be detected by means of the second and third sensors 142, 443 in the form of inductive sensors. The second and third sensors 142, 143 are mounted together with the first and second stopping members 112, 113, respectively. Hence, when the handle 130 reaches the first position corresponding to the open valve position, the second sensor 142 detects the male engagement member 131, and when the handle 130 reaches the second position corresponding to the closed valve position, the third sensor 143 detects it.

A locking member 125, herein in the form of a latch, is further provided. The locking member 125 is configured to releasably lock the lid 120 in a closed lid position as illustrated in FIG. 3a. The locking member is configured such that it can be released by the driver when he/she wants to open the lid 120 and gain access to the handle 130. FIG. 4 illustrates the mounting arrangement 100 in a top view with the lid 120 closed and locked by the locking member 125.

In the illustrated example, the bracket 110 is provided with an open front side 115 and a rear wall 116. The open front side 115 is configured to be directed toward the housing 201 of the air distribution device 200. Hoses and other connections (not shown) may thereby easily be drawn between the air distribution device 200 and the emergency braking system 101 via the open front side 115 of the bracket 110. The bracket 110 further comprises upper and lower peripheral walls 114a, 114b as well as a first peripheral side wall 114c opposite to the lid 120. Attachment portions 119a, 119b, 119c configured for mounting of the bracket 110 to the housing 201 are also provided.

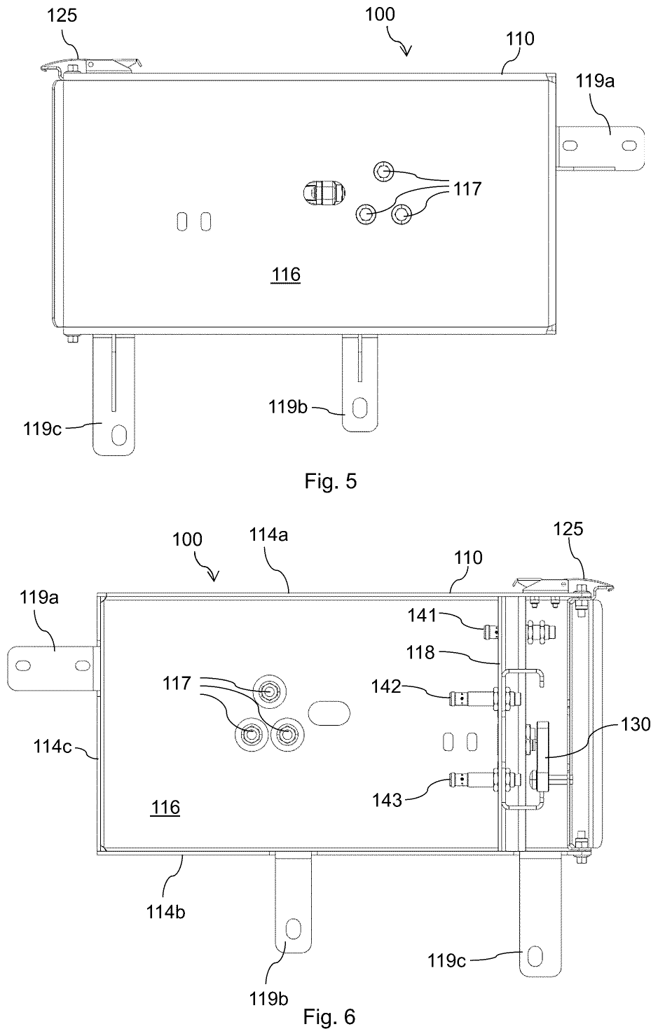

FIG. 5, illustrates the mounting arrangement 100 in a rear view and FIG. 6, shows a front view of the mounting arrangement 100 without the backup brake valve arrangement 102 mounted thereto. As illustrated herein, fastening members 117, such as screws, can be used for mounting the backup brake valve arrangement 102 to the rear wall 116.

The bracket 110 in the illustrated example further comprises an internal partition wall 118 to which the manual valve 103, the stopping members 112, 113 and the sensors 141, 142, 143 are mounted. The internal partition wall 118 covers and protects the backup brake valve arrangement 102 when the lid 120 is opened by the driver.

The bracket 110 and/or the lid 120 may be made of a metal material, such as aluminium, or of a plastic or composite material. In case inductive sensors are used, the lid 120 may comprise a metal element configured to be detectable by the first sensor 141, such as a steel element.

Below follows a list of numbered examples of the present disclosure.

Example 1. A mounting arrangement (100) for mounting of an emergency braking system (101) to a vehicle (1), the mounting arrangement comprising:
a bracket (110) configured to mount a set of components, wherein the set of components comprise at least a backup brake valve arrangement (102) and a manual valve (103) for selectively enabling activation of the backup brake valve arrangement (102),
a lid (120) pivotably mounted to the bracket (110), wherein the lid (120) is arranged to allow access to the manual valve (103) mounted to the bracket (110) when the lid (120) is open, and wherein the lid (120) is arranged to lock the manual valve (103) to one of an open valve position and a closed valve position when the lid (120) is closed,

wherein the bracket (110) is configured as a protective cover at least partially enclosing the set of components when mounted thereto.

Example 2. The mounting arrangement of example 1, further comprising:
a handle (130) configured to be assembled with the manual valve (103) to enable opening and closing of the manual valve (103).

Example 3. The mounting arrangement of example 2, wherein the handle (130) comprises a first engagement member (131) configured to engage with at least one second engagement member (121, 122) of the lid (120) to lock the manual valve (103).

Example 4. The mounting arrangement of example 3, wherein the lid (120) comprises two second engagement members (121, 122).

Example 5. The mounting arrangement of example 3 or 4, wherein the first engagement member (131) is a male engagement member, and wherein the at least one second engagement member (121, 122) comprises first and second through-holes (121, 122) configured for receiving the first engagement member (131) in the open and closed valve positions, respectively.

Example 6. The mounting arrangement of any one of examples 2-5, further comprising first and second stopping members (112, 113) attached to the bracket (110) and arranged to prevent movement of the handle (130) beyond positions corresponding to the open and closed valve positions, respectively.

Example 7. The mounting arrangement of any one of the preceding examples, further comprising a set of sensors (141, 142, 143) mounted to the bracket (110), wherein the set of sensors (141, 142, 143) comprises a first sensor (141) arranged to detect when the lid (120) is closed.

Example 8. The mounting arrangement of example 7, wherein the first sensor (141) is an inductive sensor.

Example 9. The mounting arrangement of example 7 or 8, wherein the set of sensors (141, 142, 143) further comprises a second sensor (142) configured to detect when the manual valve (103) is in the open valve position and/or a third sensor (143) configured to detect when the manual valve (103) is in the closed valve position.

Example 10. The mounting arrangement of example 9, wherein the second sensor (142) is an inductive sensor, and/or wherein the third sensor (143) is an inductive sensor.

Example 11. The mounting arrangement of any one of the preceding examples, further comprising a locking member (125), such as a latch, configured to releasably lock the lid (120) in a closed lid position.

Example 12. The mounting arrangement of any one of the preceding examples, wherein, in the closed valve position, the backup brake valve arrangement (102) is inactive, and, in the open valve position, the backup brake valve arrangement (102) is active.

Example 13. The mounting arrangement of any one of the preceding examples, wherein the bracket comprises an open side (115), and wherein the bracket (110) is configured to be mounted with the open side toward a housing (201) of an air distribution device (200) of the vehicle (1).

Example 14. The mounting arrangement of example 12, wherein the mounting arrangement (100) is configured to be mounted in a space provided between the housing (201) of the air distribution device (200) and a fuel tank (2) of the vehicle.

Example 15. The mounting arrangement of any one of the preceding examples, wherein the manual valve (103) is configured to selectively fluidly connect the backup brake valve arrangement (102) to a compressed air source, such as to an air distribution device (200) of the vehicle (1).

Example 16. The mounting arrangement of any one of the preceding examples, wherein the bracket (110) is made of a metal, such as aluminium.

Example 17. The mounting arrangement of any one of the preceding examples, wherein the lid (120) is made of a metal, such as aluminium.

Example 18. An emergency braking system (101) of a vehicle (1), comprising a backup brake valve arrangement (102), a manual valve (103) for selectively activating the backup brake valve arrangement (102), and the mounting arrangement (100) of any one of the preceding examples.

Example 19. A vehicle (1) comprising the emergency braking system (101) of example 18.

Example 20. The vehicle according to example 19, wherein the vehicle (1) is configured to be operated in an autonomous driving mode when the backup valve arrangement (102) is active, and in a manual driving mode when the backup brake valve arrangement (102) is inactive.

The terminology used herein is for the purpose of describing particular aspects only and is not intended to be limiting of the disclosure. As used herein, the singular forms “a”, “an”, and “the” are intended to include the plural forms as well, unless the context clearly indicates otherwise. As used herein, the term “and/or” includes any and all combinations of one or more of the associated listed items. It will be further understood that the terms “comprises”, “comprising”, “includes”, and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A mounting arrangement for mounting of an emergency braking system to a vehicle, the mounting arrangement comprising:
a bracket configured to mount a set of components, wherein the set of components comprise at least a backup brake valve arrangement and a manual valve for selectively enabling activation of the backup brake valve arrangement,
a lid pivotably mounted to the bracket, wherein the lid is arranged to allow access to the manual valve mounted to the bracket when the lid is open, and wherein the lid is arranged to lock the manual valve to one of an open valve position and a closed valve position when the lid is closed,
wherein the bracket is configured as a protective cover at least partially enclosing the set of components when mounted thereto.

2. The mounting arrangement of claim 1, further comprising:
a handle configured to be assembled with the manual valve to enable opening and closing of the manual valve.

3. The mounting arrangement of claim 2, wherein the handle comprises a first engagement member configured to engage with at least one second engagement member of the lid to lock the manual valve.

4. The mounting arrangement of claim 3, wherein the lid comprises two second engagement members.

5. The mounting arrangement of claim 3, wherein the first engagement member is a male engagement member, and wherein the at least one second engagement member comprises first and second through-holes configured for receiving the first engagement member in the open and closed valve positions, respectively.

6. The mounting arrangement of claim 2, further comprising first and second stopping members attached to the bracket and arranged to prevent movement of the handle beyond positions corresponding to the open and closed valve positions, respectively.

7. The mounting arrangement of claim 1, further comprising a set of sensors mounted to the bracket, wherein the set of sensors comprises a first sensor arranged to detect when the lid is closed.

8. The mounting arrangement of claim 7, wherein the first sensor is an inductive sensor.

9. The mounting arrangement of claim 7, wherein the set of sensors further comprises a second sensor configured to detect when the manual valve is in the open valve position and/or a third sensor configured to detect when the manual valve is in the closed valve position.

10. The mounting arrangement of claim 9, wherein the second sensor is an inductive sensor, and/or wherein the third sensor is an inductive sensor.

11. The mounting arrangement of claim 1, further comprising a locking member, such as a latch, configured to releasably lock the lid in a closed lid position.

12. The mounting arrangement of claim 1, wherein, in the closed valve position, the backup brake valve arrangement is inactive, and, in the open valve position, the backup brake valve arrangement is active.

13. The mounting arrangement of claim 1, wherein the bracket comprises an open side, and wherein the bracket is configured to be mounted with the open side toward a housing of an air distribution device of the vehicle.

14. The mounting arrangement of claim 12, wherein the mounting arrangement is configured to be mounted in a space provided between the housing of the air distribution device and a fuel tank of the vehicle.

15. The mounting arrangement of claim 1, wherein the manual valve is configured to selectively fluidly connect the backup brake valve arrangement to a compressed air source.

16. The mounting arrangement of claim 1, wherein the bracket is made of a metal.

17. The mounting arrangement of claim 1, wherein the lid is made of a metal.

18. An emergency braking system of a vehicle, comprising a backup brake valve arrangement, a manual valve for selectively activating the backup brake valve arrangement, and the mounting arrangement of claim 1.

19. A vehicle comprising the emergency braking system of claim 18. 10 20. The vehicle according to claim 19, wherein the vehicle is configured to be operated in an autonomous driving mode when the backup valve arrangement is active, and in a manual driving mode when the backup brake valve arrangement is inactive.
